(19) United States
(12) Patent Application Publication
(10) Pub. No.: US 2009/0229348 A1
(43) Pub. Date: Sep. 17, 2009

(54) REAL TIME LEAK DETECTION SYSTEM OF PROCESS CHAMBER

(75) Inventor: Bong-Joo Woo, Gyeonggi-do (KR)

Correspondence Address: CANTOR COLBURN, LLP, 20 Church Street, 22nd Floor, Hartford, CT, 06103, US

(73) Assignee: SEMISYSCO CO., LTD., Suwon-si (KR)

(21) Appl. No.: 12/306,140

(22) PCT Filed: Jun. 27, 2007
(86) PCT No.: PCT/KR07/03120

§ 371 Date: Dec. 22, 2008

(30) Foreign Application Priority Data
Jun. 28, 2006 (KR) 10-2006-0058820

(51) Int. Cl. G01M 3/00; G01J 3/00

(52) U.S. Cl. 73/40.5 R; 356/300

(57) ABSTRACT

Provided is a technology for detecting a leak of a process chamber in real time generated from a semiconductor substrate manufacturing process using an apparatus using plasma in a vacuum state. The real time leak detection system of a process chamber can detect a leak through end point detection (EPD) whether spectrums of nitrogen, oxygen, argon, and so on, are generated in a plasma spectrum as external air is injected into the process chamber due to the leak, and determining occurrence of the leak from the process chamber through a helium leak detector on the basis of the detection signal, without shutdown of equipment. Therefore, when the leak occurs from the process chamber, its detection time can be reduced to improve productivity. In addition, cracks in the process chamber used in a high temperature HDP CVD process can be readily checked to prevent damage to the process chamber and accidents due to the damage.

### TECHNICAL FIELD

The present invention relates to a technology for detecting a leak of a process chamber in real time generated from a semiconductor substrate manufacturing process using an apparatus using plasma in a vacuum state, for example, a chemical vapor deposition (CVD) apparatus, a high density plasma chemical vapor deposition (HDP CVD) apparatus, or an etcher, and more particularly, a real time leak detection system of a process chamber capable of determining existence of a leak from the process chamber depending on a signal generated when spectrums of nitrogen (N₂), oxygen (O₂), argon (Ar), and so on, are monitored in plasma spectrums. The N₂, O₂, and Ar spectrums are generated when external air is injected through a leak part existed in the process chamber while plasma emitted form the process chamber is monitored.

### BACKGROUND ART

As is well known, during a semiconductor substrate manufacturing process through equipment using plasma in a vacuum state, a semiconductor, a dielectric material, a conductive material, for example, polysilicon, silicon dioxide, and aluminum layers are deposited on a substrate, and the layers are etched to form a pattern of a gate, a via, a contact hole or an interconnection line.

At this time, the layers are typically formed by a chemical vapor deposition (CVD), physical vapor deposition (PVD), or oxidation and nitriding process.

For example, a reactive gas is dissolved to deposit a material layer on a substrate during the CVD process, and a target is sputtered to deposit a material on a substrate during the PVD process.

In the oxidation and nitriding process, a silicon dioxide layer or a silicon nitride layer as an oxidation layer or a nitride layer is formed on a substrate. In an etching process, a patterned mask layer or a hard mask for photoresist is formed on the substrate by a photolithography method such that an exposed part of the substrate is etched by an activated gas such as Cl₂, HBr, or BCl₃.

In these deposition processes through equipment using plasma in a vacuum state, when occurrence of the leak from the process chamber causes malfunction of the equipment, it is very difficult to find the leak occurrence time in real time.

That is, when a leak occurs in the process chamber during the deposition process, the equipment should be shut down at every shift and fully pumped. Then, pressure variation in the process chamber is measured, with all valves being closed, to check whether the leak has occurred or not. In this case, the check operation is time-consuming (for example, about 20-30 minutes), and the shutdown of the equipment causes a reduction in productivity.

Therefore, although cracks occur in the process chamber during a process using high temperature HDP CVD equipment, since the process chamber may be cooled while the leak is checked during the shutdown of the equipment, the cracks may not be checked to thereby cause damage to the process chamber.

### DISCLOSURE

### Technical Problem

In order to solve the foregoing and/or other problems, the present invention provides a real time leak detection system of a process chamber capable of detecting through end point detection (EPD) whether spectrums of nitrogen (N₂), oxygen (O₂), argon (Ar), and so on, are generated in a plasma spectrum as external air is injected into the process chamber, and determining occurrence of a leak from the process chamber through a helium (He) leak detector on the basis of the detection signal, without shutdown of equipment.

### Technical Solution

One aspect of the present invention provides a real time leak detection system of a process chamber in an apparatus using plasma in a vacuum state comprising a process chamber, a plasma gas, and an optical window to etch or deposit a desired thin layer on a surface of a liquid crystal display glass substrate or a semiconductor substrate by injecting a process gas, which comprises: a spectrum detection part for monitoring plasma emission from the process chamber during a substrate holding, deposition or etching process of the apparatus using plasma, and detecting whether spectrums of nitrogen, oxygen, and argon are included in the plasma emission; a leak detection part for analyzing a spectrum signal detected by the spectrum detection part to detect whether a leak occurs from the process chamber; and a main computer for outputting an alarm signal on the basis of the leak detected by the leak detection part.

In addition, the spectrum detection part may be an optical module for collecting plasma light in the process chamber and analyzing the collected plasma light.

Further, the optical module may comprise: an optical probe for monitoring the plasma light in the process chamber; a light collecting part for collecting the plasma light in the process chamber monitored through the optical probe and converting the plasma light into an electrical signal; and an optical analysis part for generating a waveform of an optical image on the basis of the electrical signal of the plasma signal converted through the optical collecting part.

Furthermore, the leak detection part may detect a leak when cracks occur in the process chamber so that external air is injected thereinto and nitrogen spectrum existing in the injected external air exists in a waveform of the optical image generated by the optical analysis part.

### Advantageous Effects

Therefore, when a leak occurs from a process chamber, its detection time can be reduced to improve productivity. In addition, cracks in the process chamber used in a high temperature HDP CVD process can be readily checked to prevent damage to the process chamber and accidents due to the damage.

### DESCRIPTION OF DRAWINGS

These and/or other aspects and advantages of the present invention will become apparent and more readily appreciated from the following description of exemplary embodiments of the invention, taken in conjunction with the accompanying drawings of which:

FIG. 1 is a schematic view of a real time leak detection system of a process chamber in accordance with an exemplary embodiment of the present invention;

FIG. 2 is a graph showing variation of a nitrogen spectrum when a leak occurs during a chemical vapor deposition process; and

FIG. 3 is a graph showing occurrence of a leak during a wafer holding step and a deposition step while a chemical vapor deposition process is performed.

### MODES OF THE INVENTION

Exemplary embodiments of the present invention will now be described in detail with reference to the accompanying drawings.

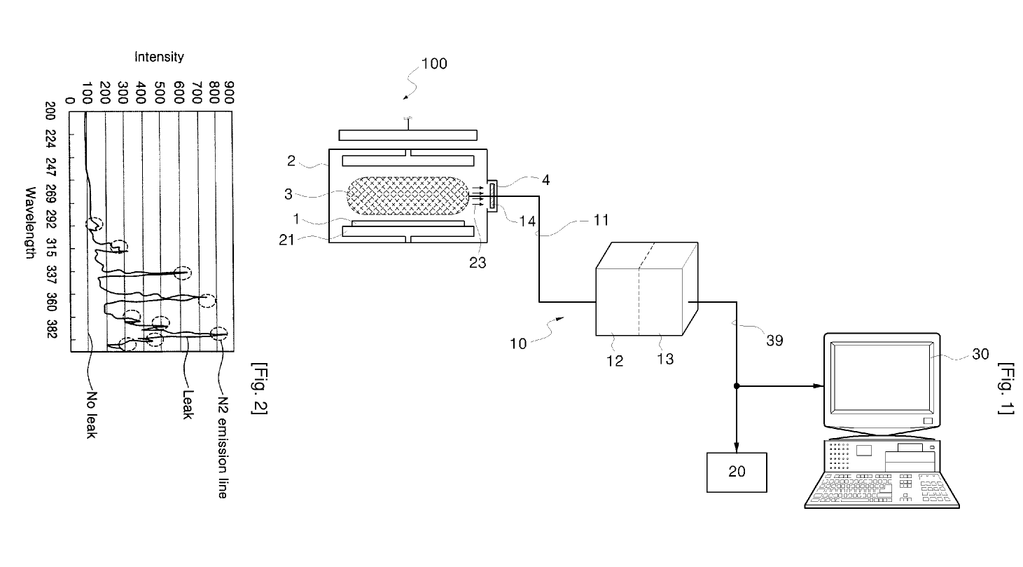

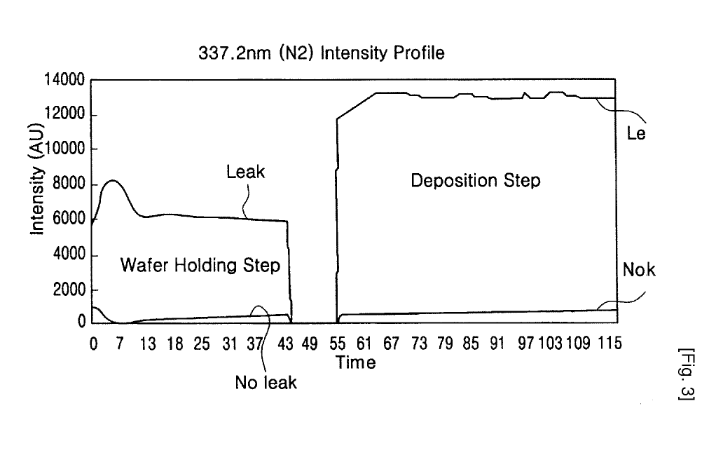

FIG. 1 is a schematic view of a real time leak detection system of a process chamber in accordance with an exemplary embodiment of the present invention, FIG. 2 is a graph showing variation of a nitrogen spectrum when a leak occurs during a chemical vapor deposition process, and FIG. 3 is a graph showing occurrence of a leak during a wafer holding step and a deposition step while a chemical vapor deposition process is performed.

Referring to FIGS. 1 to 3, the real time leak detection system in accordance with an exemplary embodiment of the present invention includes a CVD (or etching) apparatus 100 having a process chamber 2, a plasma gas 3, and an optical window 4. A spectrum detection part 10, a leak detection part 20, and a main computer 30 are connected to the CVD apparatus 100. A process gas is injected into the process chamber 2 to deposit a thin layer on a surface of a LCD glass substrate 1 or a semiconductor substrate or to etch the thin layer.

The spectrum detection part 10 is an end point detection part for monitoring plasma emission passing through the optical window 4 of the process chamber 2 during a CVD or etching process of the CVD (or etching) apparatus, and detecting whether spectrums of nitrogen (N₂), oxygen (O₂), argon (Ar), and so on, are included in the plasma emission. The spectrum detection part 10 includes an optical probe 11, a light collecting part 12, and an optical analysis part 13.

The optical probe 11 is disposed between the optical window 4 and the light collecting part 12. One end of the optical probe 11 is disposed in the process chamber 2 beyond the optical window 4, and the other end of the optical probe 11 is in contact with the light collecting part 12. The optical probe 11 includes an optical fiber that can monitor plasma light.

The light collecting part 12 is disposed between the optical analysis part 13 and the optical window 4. The light collecting part 12 is configured to collect the plasma light through the optical probe 11 in the process chamber 2 and then to convert the plasma light into an electrical signal. The plasma light is collected by an optical filter, a monochromator, or a charge coupled device (CCD), which may be included in the light collecting part 12.

At this time, the CCD may have resolution of 0.1-10 nm in a waveband of 200-1100 nm.

The optical analysis part 13 is electrically connected to the light collecting part 12 to receive the plasma light converted into the electrical signal from the light collecting part 12 to thereby generate an optical image. The optical image is formed as binary data readable by the leak detection part 20 and the main computer 30. Of course, the binary data may be generated using an image trace through a moving average method.

That is, the moving average method is performed by finely dividing a process time of the etching or deposition process at predetermined intervals as shown in FIG. 3, and corresponding the data to the divided time.

The leak detection part 20 is constituted of a He leak detector for analyzing a spectrum signal analyzed by the optical analysis part 13 and detecting occurrence of the leak in the process chamber 2. The leak is detected when external air is injected into the process chamber 2 and N2 spectrum existing in the injected external air exists in a waveform of an optical image generated by the optical analysis part 13.

The main computer 30 outputs an alarm signal such that an operator can recognize the leak occurrence by detecting the leak through the leak detection part 20 in real time to shut down the CVD (or etching) apparatus. The main computer 30 is connected to the spectrum detection part 10 and the leak detection part 30 through a cable.

Here, the alarm signal may include an audible sound or a visible flickering of a lamp.

Operation of the real time leak detection system in accordance with an exemplary embodiment of the present invention will be described below with reference to FIGS. 1 to 3.

First, when a process gas is injected into the process chamber 2 of the CVD (or etching) apparatus 100 and then a radio frequency (RF) power is applied, the process gas injected into the process chamber 2 is activated in plasma by a radio frequency generated from a process RF generating apparatus (not shown) to deposit a thin layer on a substrate 1.

During the thin layer deposition process, when the leak occurs in the process chamber 2 to cause the external air to be injected thereinto, the spectrum detection part 10 connected to the process chamber 2 and monitoring plasma emission through the optical window 3 of the process chamber 2 detects whether spectrums of nitrogen (N₂), oxygen (O₂), argon (Ar), and so on, are included in the monitored plasma emission.

Specifically, the present invention is implemented under the condition that there is no nitrogen (N₂) in the process chamber 2 during the CVD (or etching) process. Therefore, when the external air including N₂ about 78%, O₂ about 20%, and Ar about 1% is injected into the process chamber 2, the spectrum detection part 10 detects whether the spectrums of nitrogen (N₂), oxygen (O₂), argon (Ar) in the external air are included in the plasma emission, and then, transmits the detection result to the leak detection part 30.

More specifically, the spectrum detection part 10 as an optical module includes the optical probe 11, the light collecting part 12, and the optical analysis part 13.

The optical probe 11 probes plasma light in the process chamber 2, and the light collecting part 12 collects the plasma light probed through the optical probe 11 in the process chamber 2 and converts the plasma light into an electrical signal to transmit it to the optical analysis part 13.

At this time, the optical analysis part 13 receives the plasma light converted into an electrical signal from the light collecting part 12 and the spectrum signals of nitrogen (N₂), oxygen (O₂) and argon (Ar) included therein to generate an optical image through the signals. The optical image is converted into binary data (or an image trace) to be transmitted to the leak detection part 20 constituted of the He leak detector.

Then, the leak detection part 20 analyzes the spectrum signal analyzed by the optical analysis part 13 to detect occurrence of the leak in the process chamber.

That is, as shown in FIG. 3, although nitrogen (N₂) should not be included in the process chamber 2 while the wafer holding or deposition step is performed through the CVD (or etching) apparatus 100, when the external air is injected into the process chamber 2, the spectrum signal of N₂ is detected as shown in FIGS. 2 and 3.

Therefore, the leak detection part 20 can detect in real time occurrence of the leak in the process chamber 2 on the basis of the N₂ spectrum signal, without shutdown of the CVD (or etching) apparatus 100.

Meanwhile, when the leak detection part 20 detects the leak occurrence, the detection signal is transmitted to the main computer 30. Therefore, the main computer 30 generates an alarm signal to allow an operator to recognize the leak occurrence in the process chamber 20. As a result, it is possible to prevent damage to the process chamber 2 due to excessive operation of the CVD (or etching) apparatus.

While exemplary embodiments of the present invention have been shown and described, it will be appreciated by those skilled in the art that various changes may be made to the embodiments without departing from the spirit and scope of the invention as defined by the appended claims and their equivalents.

1. A real time leak detection system of a process chamber in an apparatus using plasma in a vacuum state comprising a process chamber, a plasma gas, and an optical window to etch or deposit a desired thin layer on a surface of a liquid crystal display glass substrate or a semiconductor substrate by injecting a process gas, which comprises:
a spectrum detection part for monitoring plasma emission from the process chamber during a substrate holding, deposition or etching process of the apparatus using plasma, and detecting whether spectrums of nitrogen, oxygen, and argon are included in the plasma emission;
a leak detection part for analyzing a spectrum signal detected by the spectrum detection part to detect whether a leak occurs from the process chamber; and
a main computer for outputting an alarm signal on the basis of the leak detected by the leak detection part.

2. The real time leak detection system of a process chamber according to claim 1, wherein the plasma light emission passes through the optical window to be introduced into the spectrum detection part in order to detect the leak in the process chamber.

3. The real time leak detection system of a process chamber according to claim 2, wherein the spectrum detection part is an optical module for collecting plasma emission in the process chamber and analyzing the collected plasma emission.

4. The real time leak detection system of a process chamber according to claim 3, wherein the optical module comprises:
an optical probe for monitoring plasma light in the process chamber;
a light collecting part for collecting the plasma light in the process chamber monitored through the optical probe and converting the plasma light into an electrical signal; and
an optical analysis part for generating a waveform of an optical image on the basis of the electrical signal of the plasma signal converted through the optical collecting part.

5. The real time leak detection system of a process chamber according to claim 1, wherein the leak detection part detects a leak when external air is injected into the process chamber and nitrogen spectrum existing in the injected external air exists in a waveform of the optical image generated by the optical analysis part.
